(19) United States
(12) Patent Application Publication
(10) Pub. No.: US 2008/0009284 A1
(43) Pub. Date: Jan. 10, 2008

(54) Load balancing based on free space of visitor location register

(75) Inventors: Haibo Zhang, San Jose, CA (US); Xidong Wu, Livermore, CA (US); Donggen Zhang, Fremont, CA (US); Sun-Uk Park, Union City, CA (US)

Correspondence Address: TOLER SCHAFFER, LLP, 8500 BLUFFSTONE COVE, SUITE A201, AUSTIN, TX, 78759, US

(73) Assignee: SBC Knowledge Ventures, LP, Reno, NV (US)

(21) Appl. No.: 11/483,194

(22) Filed: Jul. 7, 2006

(51) Int. Cl. H04Q 7/20

(52) U.S. Cl. 455/435.1; 455/433

(57) ABSTRACT

A load balancer assigns a mobile registration request to a mobile communication processing server (MCPS) based on an amount of free space in a visitor location register (VLR) of the MCPS. In an embodiment, the load balancer assigns the mobile registration request to the MCPS with a probability equal to the amount of free space in the VLR divided by a total amount of free space in a plurality of VLRs of a plurality of MCPSs, the plurality of MCPSs including the MCPS.

### FIELD OF THE DISCLOSURE

The present disclosure is generally related to load balancing for servers used in mobile communications.

### BACKGROUND

Load balancing algorithms are used to assign each of a plurality of incoming requests to one of a plurality of Mobile Communication Processing Servers (MCPSs). Existing load balancing algorithms use either a round-robin assignment, or a number of concurrent sessions, or a measure of server central processing unit (CPU) usage to attempt to balance the incoming requests for the MCPSs. A shortcoming of existing load balancing algorithms is that an imbalance may accumulate to an extent that causes load shedding and service outage for some customers.

### BRIEF DESCRIPTION OF THE DRAWINGS

FIG. 1 is a block diagram of an embodiment of a system for load balancing based on Visitor Location Register (VLR) free space;

FIG. 2 is a flow chart of an embodiment of a method of load balancing based on VLR free space; and

FIG. 3 is a block diagram of an illustrative embodiment of a general computer system.

### DETAILED DESCRIPTION OF THE DRAWINGS

Disclosed herein are embodiments of methods and systems for load balancing based on a measure of free space of a respective Visitor Location Register (VLR) memory of each of a plurality of mobile communication processing servers. Distributing a request to a mobile server based on the free space of its VLR memory mitigates accumulation of imbalances and causes imbalances to diminish.

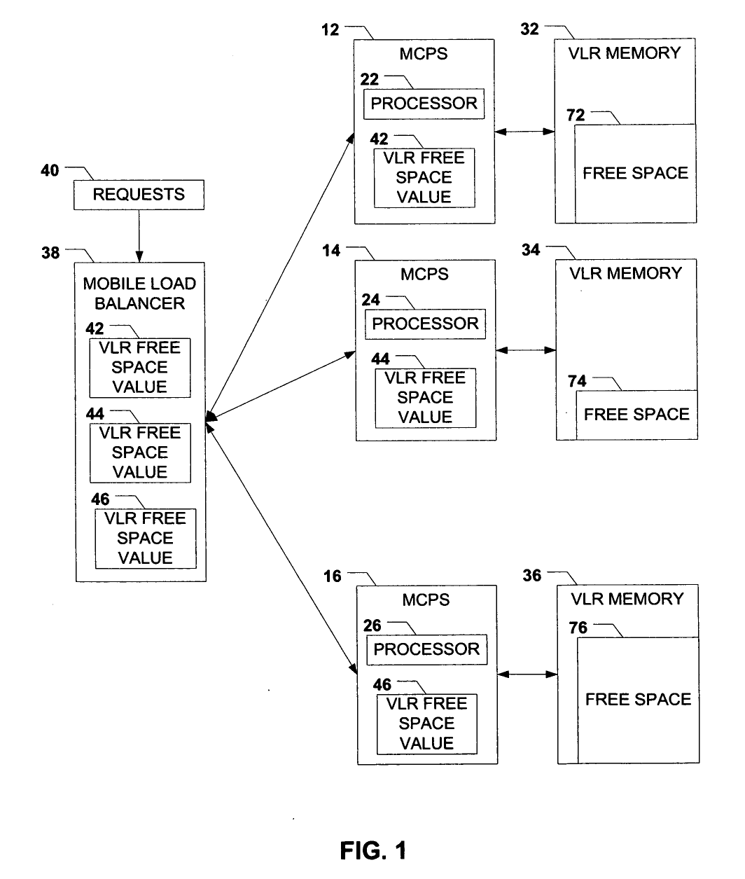

FIG. 1 is a block diagram of an embodiment of a load balancing system. The system comprises a plurality of mobile servers 10 such as mobile communication processing servers (MCPSs). For purposes of illustration and example, three MCPSs 12, 14 and 16 are depicted in FIG. 1, although those having ordinary skill will recognize that the scope of this disclosure extends to any number of mobile servers N.

Each of the MCPSs 12, 14 and 16 handles mobile phone registration, such as when a mobile phone served thereby is powered up or moves to a new geographical cellular site. Each of the MCPSs 12, 14 and 16 further handles mobile phone call processing, such as when a first mobile phone served thereby places/receives a call to/from either a second mobile phone or a landline phone. Each of the MCPSs 12, 14 and 16 comprises a respective processor 22, 24 and 26 that is used to handle tasks including the aforementioned two tasks.

Each of the MCPSs 12, 14 and 14 further comprises a respective Visitor Location Register (VLR) 32, 34 and 36. Each of the VLRs 32, 34 and 36 stores or updates some mobile provisioning information (e.g. current location information), but not all information, associated with a mobile user when the mobile user powers up or moves to a new location area. Each of the VLRs 32, 34 and 36 is provided by a respective memory for efficient processing of the information stored therein. Each of the VLRs 32, 34 and 36 has a limited capacity (e.g. a respective memory size) to store mobile provisioning information. In general, any two or more of the VLRs 32, 34 and 36 may have the same capacity or different respective capacities.

The VLRs 32, 34 and 36 differ from a Home Location Register (HLR). An HLR stores more information (e.g. complete user provisioning information) than the VLR for each mobile user, and thus typically resides in a database rather than a memory.

Registration of a mobile phone served by an MCPS results in its mobile provisioning information being stored in the VLR. After the mobile provisioning information has been stored in the VLR, the mobile phone can place or receive calls (otherwise, the calls associated with the mobile phone are rejected). If the mobile phone has been idle (e.g. powered down) for a period of time (e.g. a week), or has remained in the same geographical cellular site without placing or receiving a call for the period of time, its mobile provisioning information is removed from the VLR.

The mobile registration process by a MCPS comprises usage of its processor and usage of its VLR. The mobile registration process may take either a fixed or a substantially fixed amount of time.

The registration process for a particular mobile phone causes an amount of processor usage and an amount of VLR usage due thereto. After the registration process for a particular mobile phone has successfully completed but before the particular phone is active in placing or receiving a call, a VLR usage due to the particular mobile phone remains at the same or substantially the same value, but a processor usage due to the particular mobile phone drops to zero or substantially zero. Thereafter, activity of the particular mobile phone in placing or receiving a call does not affect the VLR usage, but does affect the processor usage for the duration of the call. Therefore, whereas the processor usage due to the particular mobile phone varies in time, the VLR usage due to the particular mobile phone remains constant until the particular mobile phone's information is removed from the VLR.

An MCPS's overall processor usage for serving a plurality of mobile phones is volatile. In some cases, an MCPS's overall processor usage for serving a plurality of mobile phones can jump from 0% to 100%, or vice-versa, in a short period of time. Reliably predicting either a trend or a smooth value of an MCPS's processor usage is difficult because of its volatility. In contrast, an MCPS's overall VLR usage is stable, smooth and easier to predict its trend because of its less volatile nature.

Incoming requests to a MCPS may comprise mobile registration requests and/or mobile call requests. The processor usage due to mobile call requests is proportional or substantially proportional to its VLR usage because only registered mobile phones can make calls. Once the VLR usage has reached the full capacity of the VLR, the MCPS can still handle new mobile call requests but cannot accept any new mobile registration requests.

It is noted that an MCPS should be construed as being inclusive of any telephone network element that is used to perform a mobile registration process based on a mobile registration request and has access to a VLR.

The system comprises a mobile load balancer 38 that distributes a plurality of requests 40 to the MCPSs 12, 14 and 16 to attempt to maximize a number of requests that are handled before any of the VLR usages of the VLRs 32, 34 and 36 reaches its full capacity. The mobile load balancer 38 distributes the requests 40 based on respective VLR free space values 42, 44 and 46 of the VLRs 32, 34 and 36. Each respective VLR free space value is equal to an allocated size of its respective VLR, minus a respective VLR usage of its respective VLR. Thus, the mobile load balancer 38 assigns a request to a particular MCPS based on its VLR free space being greater than the VLR free space of the other MCPSs. As a result, more requests are assigned to an MCPS having a greater amount of VLR free space.

For example, consider a first MCPS and a second MCPS that are substantially identical. At a particular moment in time, the first MCPS has more VLR free space than the second MCPS, and thus has less occupancy than the second MCPS. To balance the load, the mobile load balancer 38 acts to assign more subsequently-received mobile registration requests to the first MCPS than to the second MCPS based on their VLR free space values. In an embodiment, the mobile load balancer 38 assigns a mobile registration request to an MCPS with a probability proportional to its VLR free space value.

This load balancing approach acts to maximize a number of requests that are distributed before any of the VLRs are full, and would fill all of the VLRs at substantially the same time for a large number of requests. This load balancing approach further acts to balance the processor usage of the respective processors of the MCPSs. Compared to the first MCPS, the second MPCS is statistically expected to have heavier mobile call activities, and thus more processor usage due to mobile calls, because of its VLR having less free space (and being more occupied). However, compared to the first MCPS, the second MCPS will receive fewer mobile registration requests, and thus will have less processor usage due to mobile registration requests. Thus, the overall processor usage, which comprises the processor usage due to the mobile calls and the processor usage due to the mobile registrations, is smoothed by this load balancing approach.

For purposes of illustration and example, consider the first MCPS having twice the VLR free space as the second MCPS at a particular moment in time. At this particular moment in time, the second MCPS may be statistically estimated to have twice as much processor usage due to mobile calls than the first MCPS. Based on the VLR free space values, the mobile load balancer 38 assigns twice as many subsequent mobile registration requests to the first MCPS than to the second MCPS. As a result, the first MCPS has twice as much processor usage due to mobile registration than the second MCPS, which acts to balance a respective overall processor usage of each MCPS. This load balancing approach further acts to balance VLR usage by assigning more subsequent mobile registration requests to an MCPS having more VLR free space.

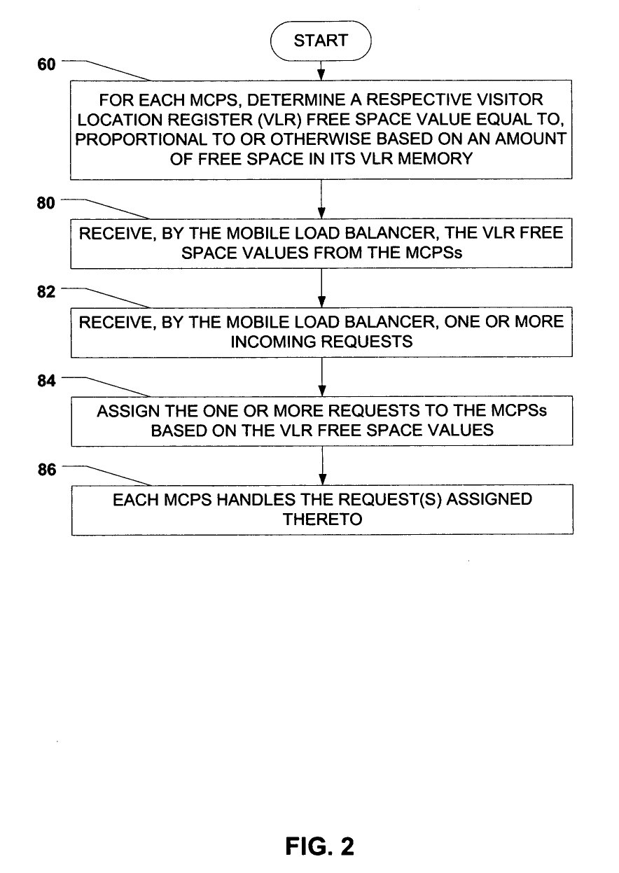

FIG. 2 is a flow chart of an embodiment of a method of load balancing. Acts depicted in FIG. 2 are described with reference to elements of FIG. 1.

As indicated by block 60, each of the MCPSs determines a respective value proportional or otherwise based on an amount of free space in its VLR memory (as indicated by block 60). For example, the MCPS 12 determines the value 42 proportional or equal to an amount of free space 72 in the VLR 32, the MCPS 14 determines the value 44 proportional or equal to an amount of free space 74 in the VLR 34, and the MCPS 16 determines the value 46 proportional or equal to an amount of free space 76 in the VLR 36. The aforementioned values may be referred to as usability values or VLR free space values. Each of the MCPSs periodically or otherwise repeatedly determines its VLR free space value, which generally varies as a function of time.

As indicated by block 80, the mobile load balancer 38 receives the respective VLR free space values from the MCPSs. In an embodiment, the mobile load balancer 38 may periodically or otherwise repeatedly poll the MCPSs for their respective VLR free space values. For example, the mobile load balancer 38 may receive and store the value 42 from the MCPS 12, the value 44 from the MCPS 14, and the value 46 from the MCPS 16.

As indicated by block 82, one or more incoming requests are received by the mobile load balancer 38. The one or more incoming requests comprise one or more mobile registration requests.

As indicated by block 84, the mobile load balancer 38 assigns the one or more requests to the MCPSs based on the VLR free space values. In an embodiment, a respective proportion of the requests assigned to each MCPS is proportional to or otherwise commensurate with the VLR free space value of the MCPS. In an embodiment, the respective proportion assigned to each MCPS is equal to its VLR free space value divided by a sum of all of the VLR free space values. Thus, for a particular request, the mobile load balancer 38 may assign the particular request to an MCPS with a probability equal to its VLR free space value divided by a sum of all of the VLR free space values. For example, the mobile load balancer 38 may assign the particular request to the MCPS 12 with a probability equal to the value 42 divided by a sum of the values 42, 44 and 46. The assignments made according to the probabilities can be either random, pseudo-random or deterministic.

As indicated by block 86, each MCPS handles the request(s) assigned thereto. Each MCPS may perform a mobile registration process for each mobile registration request assigned thereto. Further, each MCPS may facilitate a mobile call for a mobile call request associated with any of its successfully registered mobile phones.

Flow of the method can be directed back to any of the blocks 60, 80 and 82 to subsequently determine new VLR free space values, provide the new VLR free space values to the mobile load balancer 38, receive one or more subsequent incoming requests, distribute the subsequent requests to the MCPSs based on the new VLR free space values, and handle the subsequent requests by the MCPSs.

The herein-disclosed embodiments benefit from considering that processor usage due to mobile calls may be estimated as being proportional to a number of registrations in the VLR. This enables the processor usage to be balanced based on a VLR free space value rather than a measurement of processor usage. The VLR free space value is easier to monitor than processor usage. Further, load balancing is more stable and reliable because VLR free space is a smoother function of time than processor usage.

A mathematical analysis of a particular embodiment that uses a first server and a second server is as follows. The scope of this disclosure should not be construed as being limited to any of the assumptions made in the mathematical analysis for the particular embodiment.

Without loss of generality, consider the first and second servers having substantially the same hardware and software. Each of the first and second servers has a VLR memory whose full capacity is denoted by V₀. Initial occupancies of the VLR memories of the first and second servers are denoted by V₀₁ and V₀₂, respectively. At a time t, occupancies of the VLR memories of the first and second servers are denoted by v₁ and v₂, respectively, where v₁ and v₂ are functions of time t. Also at the time t, usability variables of the first and second servers are denoted by u₁ and u₂, respectively.

Each of the first and second servers has a respective CPU whose respective usage is denoted by p₁ and p₂, respectively, at the time t. Consider the CPU usage of the first server comprising call processing usage P_{C1} and mobile registration usage p_{R1}, Consider the CPU usage of the second server comprising call processing usage p_{C2} and mobile registration usage p_{R2}. Without loss of generality, consider the CPU usage substantially consisting of call processing usage and mobile registration usage. In this case, equations for p₁ and p₂ are as follows.

p₁=p_{C1}+p_{R1} (1)

p₂=p_{C2}+p_{R2} (2)

Next, consider the first and second servers at a time t+dt. Respective changes in VLR memory occupancy of the first and second servers, from time t to time t+dt, are denoted by dv₁ and dv₂, respectively. Respective changes in CPU usage of the first and second servers, from time t to time t+dt, are as follows.

dp₁=dp_{C1}+dp_{R1} (3)

dp₂=dp_{C2}+dp_{R2} (4)

Consider that, during the time interval dt, the change in the mobile registration usage comprises usage associated with incoming registration requests and usage associated with outgoing completed registrations. The incoming registration attempts may be proportional to the server's overall usability by a constant of proportionality A. The outgoing completed registration may be proportional to the server's CPU processing usage power for registration by a constant of proportionality B. Incoming traffic acts to increase the server's CPU usage, whereas outgoing completed registrations act to decrease the server's CPU usage. Thus, respective changes in the mobile registration usage of the first server and second server, being proportional to the time interval dt, can be represented as follows.

dp_{R1}=A·u₁·dt−B−p_{R1}·dt (5)

dp_{R2}=A·u₂·dt−B−p_{R1}·dt (6)

A change in VLR memory occupancy during the time interval dt may be proportional to the CPU usage associated with outgoing completed registrations during the time interval dt by a constant of proportionality η. This may occur when a fraction of any number of completed registrations end up in the VLR memory. Thus, respective changes in the VLR memory occupancy of the first and second server can be represented as follows.

dv₁=η·B·p_{R1}·dt (7)

dv₂=η·B·p_{R2}·dt (8)

Optimal processing under a maximum load condition occurs when both servers' VLR memories are filled at substantially the same time. In this case, processing power is not wasted and overloading of any one server does not occur. For example, if the memory of the first server has five times the free space and the memory of the second server, then the memory of the first server should be filled five times as fast as the memory of the second server at that moment. Using V₀ to represent the full capacity of the VLR memory, this condition can be represented by the following equation.

dv₁/dv₂=(V₀−v₁)/(V₀−v₂) (9)

The right hand side of equation (9) can be rewritten as follows based solely on the initial conditions of the memories.

(V₀−v₁)/(V₀−v₂)=(V₀−V₀₁)/(V₀−V₀₂) (10)

Thus, under the above assumptions, v₁ is linearly related to v₂. The right hand side of equation (10) is denoted by a constant C₀ that is only related to initial conditions of the memories of the first and second servers. Equations (7), (8), (9) and (10) can be combined as follows to show a linear relationship between p_{R1} and p_{R2}.

p_{R1}/p_{R2}=dv₁/dv₂=(V₀=v₁)/(V₀−v₂)=(V₀−V₀₁)/(V₀−V₀₂)=C₀ (11)

This shows that the incremental change in CPU usage associated with registration is a linear relationship from the first server to the second server. Combining equations (5) and (6) with (11) results in the following equation.

(A·u₁−B·p_{R1})/(A·u₂−B·p_{R2})=C₀ (12)

Also based on equation (11), the usability variables are related as follows.

u₁/u₂=(V₀−v₁)/(V₀−v₂)=C₀ (13)

Thus, a universal usability variable, u, is proportional to memory free space by a numerical constant α based on the following equation.

u=α(V₀−v) (14)

Because the CPU usage is proportional or otherwise correlated to memory occupancy, the CPU usage need not be known to determine the usability u. Thus, the CPU usage associated with registration may be proportional to VLR memory free space.

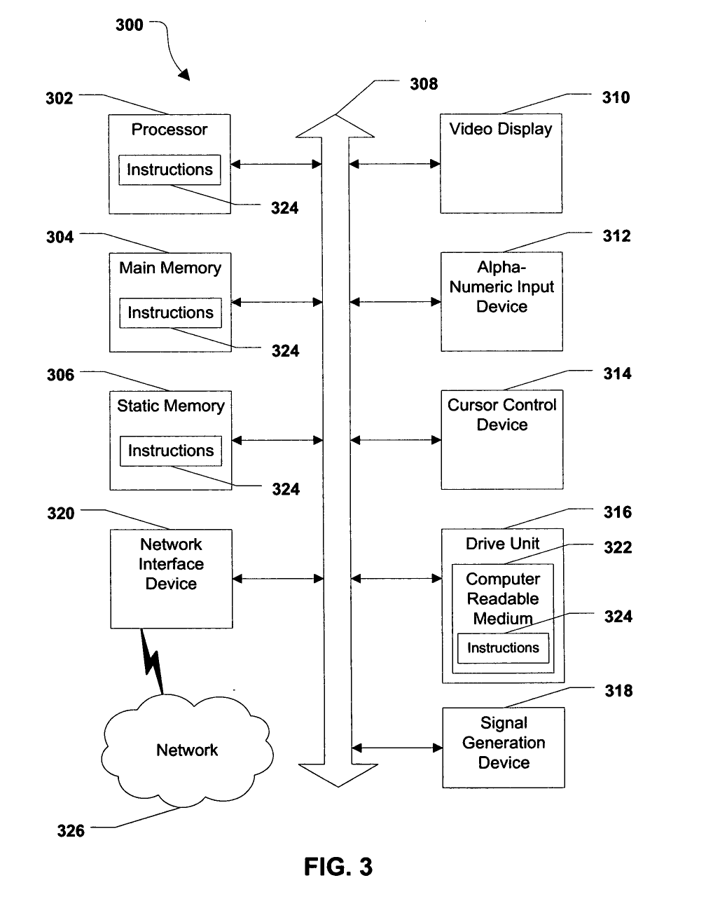

Referring to FIG. 3, an illustrative embodiment of a general computer system is shown and is designated 300. The computer system 300 can include a set of instructions that can be executed to cause the computer system 300 to perform any one or more of the methods or computer based functions disclosed herein. The computer system 300 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 300 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 300 can be implemented using electronic devices that provide voice, video or data communication. Further, while a single computer system 300 is illustrated, the term “system” shall also be taken to include any collection of systems or sub-systems that individually or jointly execute a set, or multiple sets, of instructions to perform one or more computer functions.

As illustrated in FIG. 3, the computer system 300 may include a processor 302, e.g., a central processing unit (CPU), a graphics processing unit (GPU), or both. Moreover, the computer system 300 can include a main memory 304 and a static memory 306, that can communicate with each other via a bus 308. As shown, the computer system 300 may further include a video display unit 310, such as a liquid crystal display (LCD), an organic light emitting diode (OLED), a flat panel display, a solid state display, or a cathode ray tube (CRT). Additionally, the computer system 300 may include an input device 312, such as a keyboard, and a cursor control device 314, such as a mouse. The computer system 300 can also include a disk drive unit 316, a signal generation device 318, such as a speaker or remote control, and a network interface device 320.

In a particular embodiment, as depicted in FIG. 3, the disk drive unit 316 may include a computer-readable medium 322 in which one or more sets of instructions 324, e.g. software, can be embedded. Further, the instructions 324 may embody one or more of the methods or logic as described herein. In a particular embodiment, the instructions 324 may reside completely, or at least partially, within the main memory 304, the static memory 306, and/or within the processor 302 during execution by the computer system 300. The main memory 304 and the processor 302 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 324 or receives and executes instructions 324 responsive to a propagated signal, so that a device connected to a network 326 can communicate voice, video or data over the network 326. Further, the instructions 324 may be transmitted or received over the network 326 via the network interface device 320.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system or telephone network element to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method comprising:
assigning a mobile registration request to a mobile communication processing server (MCPS) based on an amount of free space in a visitor location register (VLR) of the MCPS.

2. The method of claim 1 wherein the mobile registration request is assigned to the MCPS with a probability equal to the amount of free space in the VLR divided by a total amount of free space in a plurality of VLRs of a plurality of MCPSs, the plurality of MCPSs including the MCPS.

3. The method of claim 1 further comprising:
polling the MCPS for the amount of free space in the VLR.

4. The method of claim 1 further comprising:
receiving a value based on the amount of free space in the VLR from the MCPS.

5. The method of claim 4 further comprising:
determining, by the MCPS, the amount of free space in the VLR.

6. The method of claim 1 further comprising:
performing, by the MCPS, a mobile registration process based on the mobile registration request.

7. A system comprising:
a load balancer which assigns a mobile registration request to a mobile communication processing server (MCPS) based on an amount of free space in a visitor location register (VLR) of the MCPS.

8. The system of claim 7 wherein the load balancer assigns the mobile registration request to the MCPS with a probability equal to the amount of free space in the VLR divided by a total amount of free space in a plurality of VLRs of a plurality of MCPSs, the plurality of MCPSs including the MCPS.

9. The system of claim 7 wherein the load balancer is to poll the MCPS for the amount of free space in the VLR.

10. The system of claim 7 wherein the load balancer is to receive a value based on the amount of free space in the VLR from the MCPS.

11. The system of claim 7 wherein the MCPS is to determine the value based on the amount of free space in the VLR.

12. The system of claim 7 wherein the MCPS is to perform a mobile registration process based on the mobile registration request.

13. A computer-readable medium which encodes computer program code to cause a telephone network element to:
assign a mobile registration request to a mobile communication processing server (MCPS) based on an amount of free space in a visitor location register (VLR) of the MCPS.

14. The computer-readable medium of claim 13 wherein the mobile registration request is assigned to the MCPS with a probability equal to the amount of free space in the VLR divided by a total amount of free space in a plurality of VLRs of a plurality of MCPSs, the plurality of MCPSs including the MCPS.

15. The computer-readable medium of claim 13 wherein the computer program code further causes the telephone network element to:
poll the MCPS for the amount of free space in the VLR.

16. The computer-readable medium of claim 13 wherein the computer program code further causes the telephone network element to:
receive a value based on the amount of free space in the VLR from the MCPS.
